(19) United States
(12) Patent Application Publication
(10) Pub. No.: US 2025/0141124 A1
(43) Pub. Date: May 1, 2025

(54) CONNECTION STRUCTURE AND ASSEMBLY

(71) Applicant: Yazaki Corporation, Tokyo (JP)

(72) Inventors: Yasuhiro KOMINATO, Makinohara-shi (JP); Hajime KATO, Makinohara-shi (JP); Yukihiro KAWAMURA, Makinohara-shi (JP); Toshiharu TAKAHASHI, Makinohara-shi (JP); Syoichi NOMURA, Makinohara-shi (JP)

(73) Assignee: Yazaki Corporation, Tokyo (JP)

(21) Appl. No.: 18/921,555

(22) Filed: Oct. 21, 2024

(30) Foreign Application Priority Data
Oct. 30, 2023 (JP) 2023-185169

(51) Int. Cl. H01R 4/30

(52) U.S. Cl. CPC H01R 4/304

(57) ABSTRACT

A connection structure according to an embodiment includes: a first conductive portion including a first busbar having a contact surface; a second conductive portion disposed at a position away from the first conductive portion; a movable conductive portion including a pressing portion capable of coming into contact with the first busbar and the movable conductive portion being movable with respect to the first conductive portion and the second conductive portion in a moving direction intersecting with the contact surface; a biasing portion capable of biasing the movable conductive portion toward the contact surface; and a relay conductive portion relaying conduction between the second conductive portion and the movable conductive portion, in which the relay conductive portion is slidable with respect to the second conductive portion or the movable conductive portion.

### BACKGROUND OF THE INVENTION

### Field of the Invention

Embodiments of the present invention relate to a connection structure and an assembly.

Priority is claimed on Japanese Patent Application No. 2023-185169, filed Oct. 30, 2023, the contents of which are incorporated herein by reference.

### Description of Related Art

It is widely known that a battery pack as a power supply source is connected to a device. For example, Japanese Unexamined Patent Application, First Publication No. 2018-144524 discloses that a battery module is connected to a fuse/contactor unit of an electric vehicle.

### SUMMARY OF THE INVENTION

In an assembly disclosed in Japanese Unexamined Patent Application, First Publication No. 2018-144524, a male-side power supply-side terminal portion disposed in a battery module is attached to and detached from each of a plurality of female-side power reception-side terminal portions connected to a fuse/contactor unit. However, in such a connection structure using the terminal portions, the contact pressure between conductive portions of both units cannot be ensured in some cases.

An embodiment of the present invention provides a connection structure and an assembly that easily ensure a contact pressure between conductive portions.

A connection structure according to an embodiment of the present invention includes: a first conductive portion including a first busbar having a contact surface; a second conductive portion disposed at a position away from the first conductive portion; a movable conductive portion including a pressing portion capable of coming into contact with the first busbar and the movable conductive portion being movable with respect to the first conductive portion and the second conductive portion in a moving direction intersecting with the contact surface; a biasing portion capable of biasing the movable conductive portion toward the contact surface; and a relay conductive portion relaying conduction between the second conductive portion and the movable conductive portion, in which the relay conductive portion is slidable with respect to the second conductive portion or the movable conductive portion.

According to a connection structure and an assembly of an embodiment of the present invention, it is easy to ensure a contact pressure between conductive portions.

### BRIEF DESCRIPTION OF THE DRAWINGS

FIG. 1 is a front view of an assembly before fastening according to each of embodiments.

FIG. 2 is an enlarged view of a portion II in FIG. 1 of an assembly before fastening according to a first embodiment.

FIG. 3 is a cross-sectional view of the assembly before fastening according to the first embodiment, taken along line III-III in FIG. 1.

FIG. 4 is a cross-sectional view of the assembly after fastening according to the first embodiment, taken along line III-III in FIG. 1.

FIG. 5 is a cross-sectional view of an assembly before fastening according to a modification of the first embodiment, taken along line III-III in FIG. 1.

FIG. 6 is a cross-sectional view of an assembly before fastening according to a modification of the first embodiment, taken along line III-III in FIG. 1.

FIG. 7 is a cross-sectional view of an assembly before fastening according to a modification of the first embodiment, taken along line III-III in FIG. 1.

FIG. 8 is an enlarged view of a portion II in FIG. 1 of an assembly before fastening according to a second embodiment.

FIG. 9 is a cross-sectional view of the assembly before fastening according to the second embodiment, taken along line III-III in FIG. 1.

FIG. 10 is a cross-sectional view of the assembly before fastening according to the second embodiment, taken along line X-X in FIG. 1.

FIG. 11 is a cross-sectional view of the assembly after fastening according to the second embodiment, taken along line III-III in FIG. 1.

FIG. 12 is a cross-sectional view of an assembly before fastening according to a modification of the second embodiment, taken along line X-X in FIG. 1.

### DETAILED DESCRIPTION OF THE INVENTION

### First Embodiment

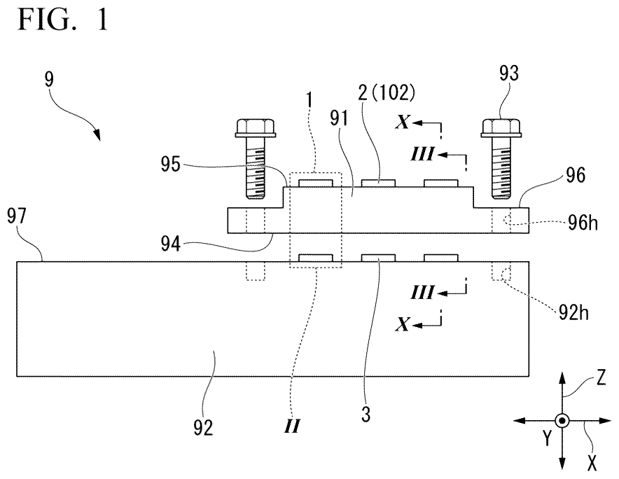

Hereinafter, a connection structure and an assembly according to an embodiment will be described with reference to FIGS. 1 to 7.

### (Configuration of Assembly)

As illustrated in FIG. 1, an assembly 9 of the present embodiment includes a plurality of connection structures 1, a device 91, a battery pack 92, and a fastening material 93. The device 91 and the battery pack 92 are fastened by the fastening material 93, whereby the assembly 9 is unitized. For example, the assembly 9 may be mounted on a mobility unit such as an electric vehicle.

### (Device)

The device 91 receives power from the battery pack 92. For example, the device 91 may be a high-voltage device such as a high-voltage junction box (J/B), an on-board charger (OBC), or a DC-DC converter. The device 91 has a facing surface 94 on a side facing the battery pack 92. The device 91 has a first installation surface 95 on a side opposite to the side facing the battery pack 92.

Hereinafter, a direction parallel to a direction in which the facing surface 94 faces is referred to as a Z direction. Hereinafter, the Z direction is also referred to as a “moving direction”. Directions intersecting with each other in a plane facing the Z direction are defined as an X direction and a Y direction. For example, the X direction, the Y direction, and the Z direction may be directions orthogonal to each other. For example, the Z direction may be an “up-down direction”. For example, the facing surface 94 may be a plane facing downward. For example, the first installation surface 95 may be a plane facing upward. For example, the facing surface 94 and the first installation surface 95 may be planes parallel to each other.

Each of the facing surface 94 and first installation surface 95 is an insulating surface made of an insulator material. For example, each of the facing surface 94 and the first installation surface 95 may be a housing having insulation properties, a cover partially having insulation properties, or the like.

The device 91 has flange portions 96 protruding on both sides in the X direction. The flange portions 96 have a plurality of through holes 96h extending in the Z direction. The device 91 and the battery pack 92 are fastened together by the fastening material 93 inserted into each of the through holes 96h.

### (Configuration of Battery Pack)

The battery pack 92 includes a plurality of battery cells. The battery pack 92 has a second installation surface 97 on a side facing the device 91. The second installation surface 97 faces the facing surface 94. For example, the second installation surface 97 may be a plane facing upward.

The battery pack 92 has a screw hole 92h in the second installation surface 97. The fastening material 93 inserted into the through hole 96h is screwed into the screw hole 92h.

The second installation surface 97 is an insulating surface made of an insulator material. For example, the second installation surface 97 may be a housing having insulation properties, a cover partially having insulation properties, or the like.

### (Configuration of Connection Structure)

The plurality of connection structures 1 are structures for electrically connecting the device 91 and the battery pack 92 to each other. The plurality of connection structures 1 are arranged side by side in the X direction. Each of the connection structures 1 is disposed from the first installation surface 95 to the second installation surface 97.

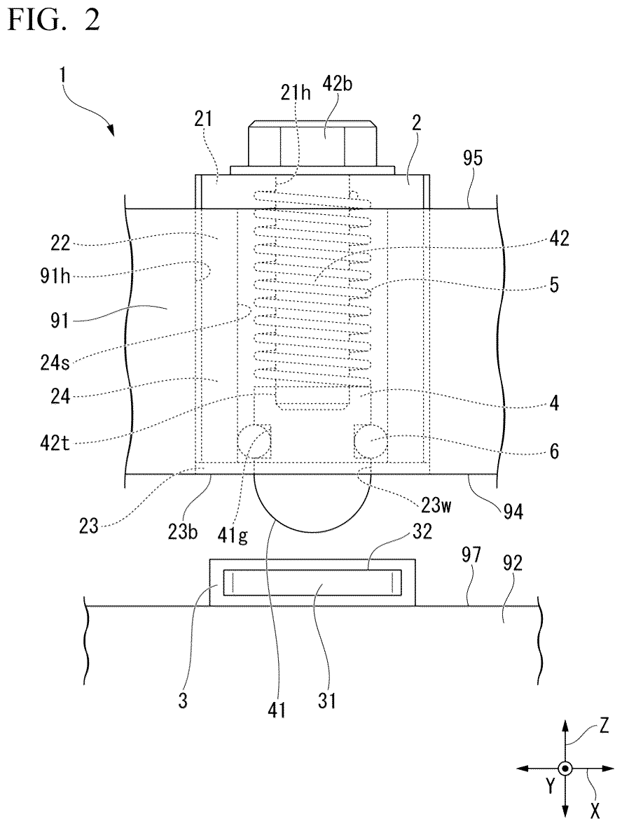

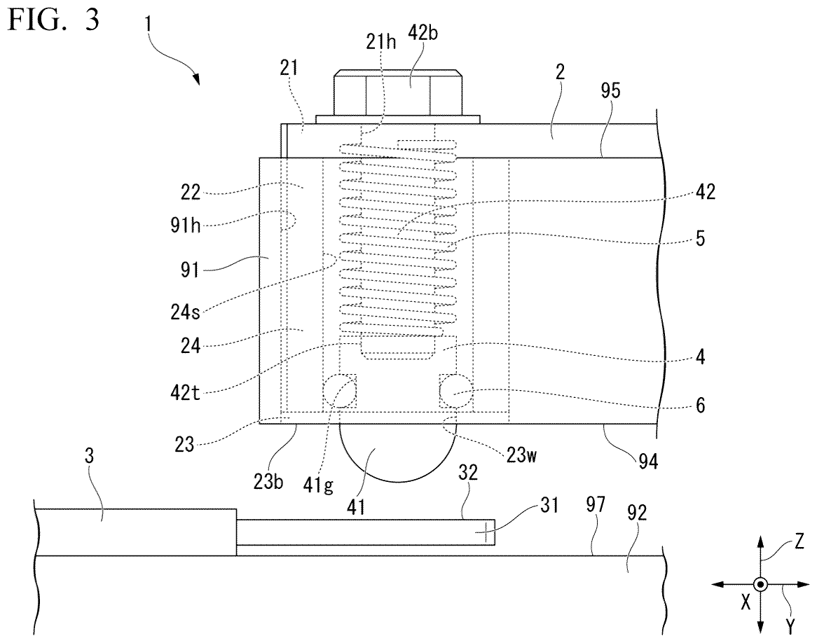

As illustrated in FIGS. 2 and 3, each of the connection structures 1 includes a device conductive portion 2 (second conductive portion), a battery conductive portion 3 (first conductive portion), a movable conductive portion 4, a biasing portion 5, and a relay conductive portion 6. Hereinafter, “conductive” means that a path through which a current flows is formed.

### (Configuration of Battery Conductive Portion)

The battery conductive portion 3 is electrically connected to an electrode included in the battery pack 92. The battery conductive portion 3 includes a battery busbar 31 (first busbar).

### (Battery Busbar)

The battery busbar 31 has a contact surface 32. The contact surface 32 is a plane. The battery busbar 31 extends in a Y direction to immediately below the movable conductive portion 4 while being in contact with the second installation surface 97. The battery busbar 31 may have a constant thickness. For example, each of the battery busbars 31 may be an integrated flat plate having a pair of plate surfaces facing the Z direction and extending in the Y direction. For example, a periphery of the battery busbar 31 may be covered with a covering material from the battery pack 92 to a front of a tip end located immediately below the movable conductive portion 4. The battery busbar 31 is made of a conductive material such as metal.

### (Configuration of Device Conductive Portion)

The device conductive portion 2 is electrically connected to the device 91. The device conductive portion 2 includes a device busbar 21 (second busbar) and a conductive housing 22. The device conductive portion 2 is disposed at a position away from the battery conductive portion 3.

### (Device Busbar)

The device busbar 21 is electrically connected to an electrode included in the device 91. The device busbar 21 extends in the Y direction in contact with the first installation surface 95, and is in contact with an upper surface of the conductive housing 22 at an extending end. For example, the device busbar 21 may have a constant thickness. For example, the device busbar 21 may be an integrated flat plate having a pair of plate surfaces facing the Z direction and extending in the Y direction. The device busbar 21 has a shaft hole 21h penetrating the device busbar 21 in the Z direction. The device busbar 21 is made of a conductive material such as metal.

### (Conductive Housing)

The conductive housing 22 supports one end of the device busbar 21 in the X direction. The conductive housing 22 is fitted in a through hole 91h of the device 91. Note that the through hole 91h is a hole that penetrates the device 91 from the first installation surface 95 to the facing surface 94 and has an opening in an up-down direction on a lower surface of the device busbar 21. The conductive housing 22 is in contact with the device busbar 21 and the relay conductive portion 6 so as to relay conduction between the device busbar 21 and the relay conductive portion 6. The conductive housing 22 includes a bottom plate 23 and a peripheral wall 24.

The bottom plate 23 has a bottom surface 23b extending in an XY plane and an opening 23w at a center of the bottom surface. The bottom surface 23b is flush with the facing surface 94. For example, the bottom plate 23 may be made of an insulating material or may be made of a conductive material such as metal. The opening 23w is opened from the inside to the outside of the conductive housing 22.

The peripheral wall 24 rises from the bottom plate 23 and extends upward so as to surround a periphery of the movable conductive portion 4. An upper surface of the peripheral wall 24 is in contact with a lower surface of the device busbar 21 so as to be electrically connected thereto. The peripheral wall 24 is made of a conductive material such as metal. For example, when the bottom plate 23 and the peripheral wall 24 are made of a conductive material, the conductive housing 22 may be made of a tubular conductor case in which the bottom plate 23 and the peripheral wall 24 are integrally formed.

### (Configuration of Movable Conductive Portion)

The movable conductive portion 4 is movable in the Z direction with respect to the device conductive portion 2 and the battery conductive portion 3. The movable conductive portion 4 includes a pressing portion 41 capable of coming into contact with the battery busbar 31 and a shaft body 42.

### (Pressing Portion)

The pressing portion 41 can come into contact with the contact surface 32 of the battery busbar 31. The pressing portion 41 has a hemispherical shape having a hemispherical surface as a curved surface on the contact surface 32 side. The pressing portion 41 has a cylindrical shape extending toward the shaft body 42 coaxially with the shaft body 42 on a side opposite to the contact surface 32 side. For example, the pressing portion 41 has an annular circumferential groove 41g centered on a central axis of the shaft body 42 on an outer periphery of the pressing portion 41. The circumferential groove 41g is recessed toward the central axis of the shaft body 42. The pressing portion 41 has an outer diameter smaller than an inner diameter of the opening 23w such that the hemispherical portion does not come into contact with the bottom plate 23 when the movable conductive portion 4 moves downward. By having such an outer diameter, the pressing portion 41 is configured such that the hemispherical portion protrudes from the opening 23w toward the contact surface 32 when the movable conductive portion 4 moves downward. The pressing portion 41 is made of a conductive material such as metal.

### (Shaft Body)

The shaft body 42 has a tip end 42t and a base end 42b. The tip end 42t of the shaft body 42 is fixed to the pressing portion 41. For example, the tip end 42t of the shaft body 42 may be screwed into and fixed to the pressing portion 41. The shaft body 42 extends upward from the tip end 42t through a cavity in the conductive housing 22, penetrates the device busbar 21, and extends to the base end 42b. An outer periphery of the shaft body 42 is enlarged at the base end 42b such that the shaft body 42 penetrating the shaft hole 21h does not come out toward the battery conductive portion 3. On the other hand, regardless of the enlargement of the outer periphery of the shaft body 42 at the base end 42b, the movable conductive portion 4 is movable in an upward direction which is a direction away from the battery conductive portion 3 with respect to the device busbar 21. For example, the base end 42b has an outer diameter larger than an inner diameter of the shaft hole 21h. For example, the shaft body 42 may be a bolt. The shaft body 42 may be made of a conductive material such as metal, or may be made of an insulating material.

### (Configuration of Biasing Portion)

The biasing portion 5 can bias the movable conductive portion 4 toward the contact surface 32. The biasing portion 5 is elastically deformable in the Z direction. The biasing portion 5 extends in the Z direction coaxially with the shaft body 42. The biasing portion 5 has an upper end fixed to the device busbar 21 and a lower end fixed to the pressing portion 41. For example, the biasing portion 5 may be a coil spring coaxial with the shaft body 42.

### (Configuration of Relay Conductive Portion)

The relay conductive portion 6 relays conduction between the device conductive portion 2 and the movable conductive portion 4. The relay conductive portion 6 is in contact with an outer peripheral surface of the pressing portion 41 and an inner peripheral surface of the conductive housing 22. For example, the relay conductive portion 6 is in contact with the circumferential groove 41g of the pressing portion 41 and an inner peripheral surface 24s of the peripheral wall 24. The relay conductive portion 6 is fixed to the movable conductive portion 4 in the Z direction, and is slidable with respect to the device conductive portion 2. Specifically, by being fitted in the circumferential groove 41g, the relay conductive portion 6 is fixed to an outer peripheral surface of the pressing portion 41 in the Z direction, and is slidable with respect to the inner peripheral surface 24s of the peripheral wall 24. The relay conductive portion 6 is elastically deformable in a radial direction of the shaft body 42 so as to come into contact with the pressing portion 41 and the device conductive portion 2. The relay conductive portion 6 is made of a conductive material such as metal. For example, the relay conductive portion 6 may be an annular obliquely wound coil spring fitted in the circumferential groove 41g.

### (Configuration of Fastening Material)

The plurality of fastening materials 93 fastens the device 91 and the battery pack 92 to each other. For example, each of the fastening materials 93 may be a bolt to be fastened to the screw hole 92h through the through hole 96h.

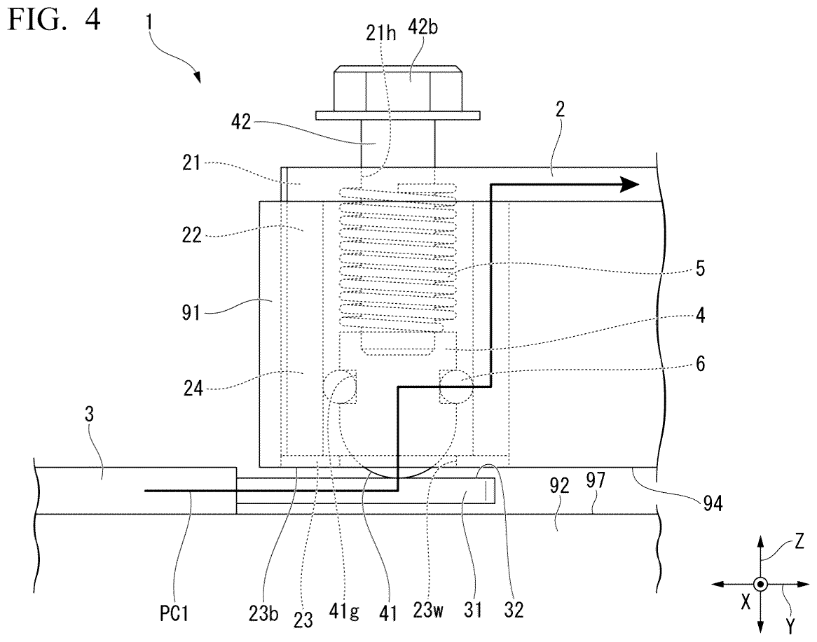

In assembling the assembly 9, for example, when the device 91 is fastened to the battery pack 92 by the fastening materials 93 so as to bring the device 91 close to the battery pack 92, the pressing portion 41 comes into contact with the contact surface 32 as illustrated in FIG. 4. When the device 91 is further fastened, the pressing portion 41 receives a pressing force upward from the contact surface 32.

Since the movable conductive portion 4 is movable in the Z direction with respect to the device conductive portion 2 and the battery conductive portion 3, the pressing portion 41 that has received the pressing force from the contact surface 32 elastically deforms the biasing portion 5. On the other hand, the elastically deformed biasing portion 5 can apply a biasing force toward the contact surface 32 to the pressing portion 41. Due to this deformation and biasing force, in the assembly 9 after assembling, the pressing portion 41 can come into contact with the contact surface 32 while absorbing the pressing force from the contact surface 32 by the biasing portion 5. As a result of the contact, for example, the connection structure 1 can be electrically connected to the device conductive portion 2 and the battery conductive portion 3 such that a current flows through a current path PC1 illustrated in FIG. 4.

### (Operation and Effect of the Invention)

According to the connection structure 1 of the present embodiment, the relay conductive portion 6 is slidable with respect to the device conductive portion 2. On the other hand, the biasing portion 5 can bias the movable conductive portion 4 toward the contact surface 32. With such a relay conductive portion 6 and biasing portion 5, the movable conductive portion 4 can come into contact with the contact surface 32 while being biased toward the contact surface 32 and absorbing the pressing force from the contact surface 32 by the biasing portion 5. With such a contact, the connection structure 1 can absorb a manufacturing tolerance related to electrical connection between the device conductive portion 2 and the battery conductive portion 3, which is likely to occur at the time of assembling the device 91 and the battery pack 92. Therefore, the connection structure 1 of the present embodiment can easily ensure a contact pressure between the device conductive portion 2 and the battery conductive portion 3.

For example, the assembly 9 can absorb a tolerance related to a dimensional error, a fastening pressure error, or the like between lots of various structures related to contact between the device conductive portion 2 and the battery conductive portion 3 for the plurality of assemblies 9 having different lots. For example, in the assembly 9, the plurality of movable conductive portions 4 across the plurality of connection structures 1 can be displaced in an up-down direction independently of each other. With such a displacement, the assembly 9 can absorb a tolerance related to a dimensional error between the plurality of device busbars 21, a dimensional error between the plurality of battery busbars 31, or the like, for one assembly 9. For example, the assembly 9 can absorb a tolerance related to a variation in contact pressure generated due to non-uniformity of fastening pressure, which is a variation in contact pressure across the plurality of device conductive portions 2 and the plurality of battery conductive portions 3 for one assembly 9.

As a comparative example, it is assumed that the structure of an assembly is a structure in which a connector is disposed in a battery pack and a vehicle body side connector and a battery side connector are connected to each other when the battery pack is attached to a vehicle body as in Japanese Unexamined Patent Application, First Publication No. 2018-144524. With such a structure of the comparative example, when there is a plurality of connecting portions, a fitting state of each connector cannot be confirmed, there may be a semi-fitted connector, a very large insertion force may be required at the time of collective connection, or component cost may be high.

In contrast to this comparative example, in the present embodiment, the structure of the assembly 9 is a structure in which the movable conductive portion 4 can come into contact with the contact surface 32 while being biased toward the contact surface 32. With this structure, even when there is a plurality of connecting portions, it is easy to ensure a contact pressure between each of the device conductive portions 2 and the relevant battery conductive portion 3 while suppressing a fastening pressure and the number of components.

In particular, when the device 91 is a high-voltage device, an electrical connection between the device 91 and the battery pack 92, which becomes an electrical connection between busbars, increases, and thus it is effective to ensure the contact pressure between the device conductive portion 2 and the battery conductive portion 3 as in the present embodiment.

In addition, according to an example of the connection structure 1 of the present embodiment, the relay conductive portion 6 is elastically deformable so as to come into contact with the pressing portion 41 and the conductive housing 22. Due to such an elastic deformation, the connection structure 1 has a structure in which an electrical connection between the pressing portion 41 and the device conductive portion 2 is easily stabilized. Therefore, the connection structure 1 of the present embodiment can stabilize an electrical connection between the device conductive portion 2 and the battery conductive portion 3.

In addition, according to an example of the connection structure 1 of the present embodiment, the relay conductive portion 6 is slidable so as to come into contact with the pressing portion 41 and the conductive housing 22. With such a contact, the connection structure 1 can stabilize the electrical connection between the device conductive portion 2 and the battery conductive portion 3 regardless of the structure of the device busbar 21.

In addition, according to an example of the connection structure 1 of the present embodiment, since the movable conductive portion 4 includes the shaft body 42, the connection structure 1 is not limited to the structure and positional relationship with the device busbar 21 and the battery busbar 31, and can have a structure in which the pressing portion 41 is easily brought into contact with the contact surface 32.

In addition, according to an example of the connection structure 1 of the present embodiment, the annular obliquely wound coil spring that is the relay conductive portion 6 is held slidably and deformably between the pressing portion 41 and the conductive housing 22. With such holding, the movable conductive portion 4 is allowed to be inclined with respect to a central axis of the conductive housing 22, and even when the device busbar 21 or the battery busbar 31 is inclined, the lower obliquely wound coil spring can be brought into contact with the battery busbar 31 perpendicularly.

### (Modification)

In the present embodiment, the pressing portion 41 has a curved surface on the contact surface 32 side. The contact surface 32 has a plane. Note that the pressing portion 41 and the contact surface 32 may be configured in any manner as long as the pressing portion 41 and the contact surface 32 can be brought into contact with each other.

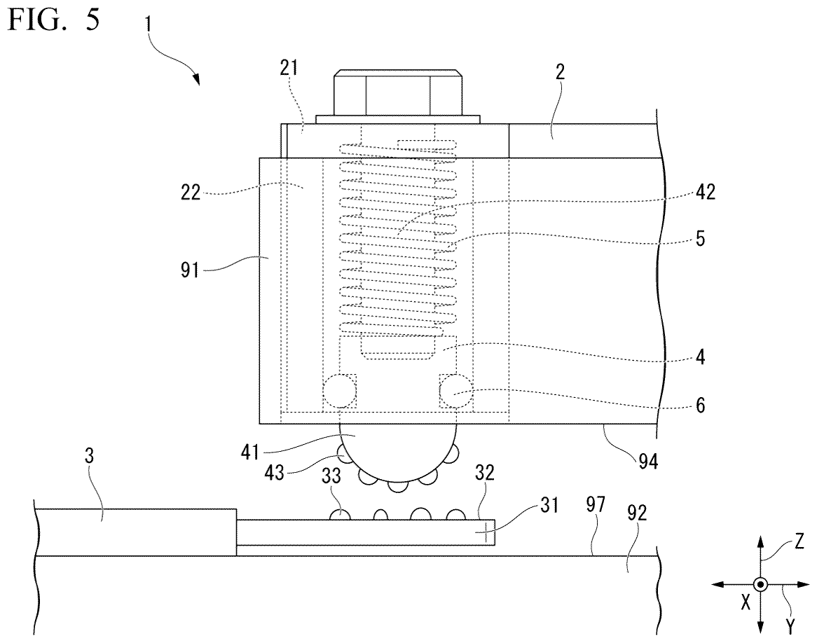

As a modification, as illustrated in FIG. 5, the pressing portion 41 may have a plurality of bosses 43 protruding from a protruding curved surface toward the contact surface 32. On the other hand, the contact surface 32 may have a plurality of bosses 33 protruding toward the protruding curved surface. Each of the plurality of bosses 33 is formed at a position where each of the bosses 33 can come into contact with the corresponding boss 43 in an in-plane direction of the contact surface 32. According to such a modification, since a contact area between the pressing portion 41 and the contact surface 32 increases, reliability of the contact can be ensured.

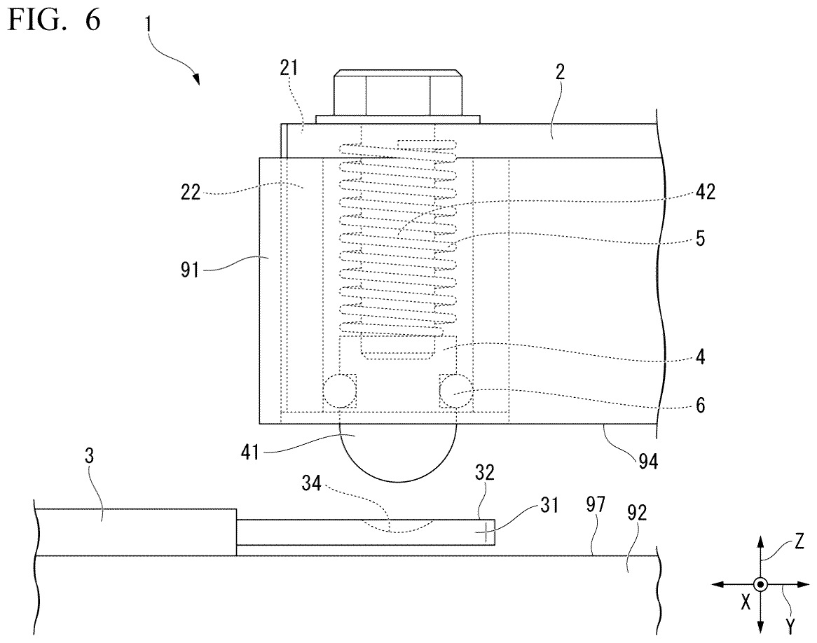

As another modification, as illustrated in FIG. 6, the contact surface 32 may have a recessed portion 34 having a recessed curved surface shape that is fitted to the protruding curved surface of the pressing portion 41 so as to be able to come into contact with the protruding curved surface. According to such a modification, since a contact area between the pressing portion 41 and the contact surface 32 increases, reliability of the contact can be ensured.

As still another modification, the pressing portion 41 may have a plane on the contact surface 32 side. Note that when the pressing portion 41 is a plane, when a product is actually formed, there are fine irregularities on a surface, and it may be difficult to manage a contact area and a contact point. Therefore, in a case where the pressing portion 41 has a curved surface to some extent on the contact surface 32 side, it is easy to manage the area and the contact point.

In an example of the present embodiment, the tip end 42t of the shaft body 42 is screwed into and fixed to the pressing portion 41. Note that any configuration may be adopted as long as the tip end 42t of the shaft body 42 is fixed to the pressing portion 41. As a modification, the shaft body 42 and the pressing portion 41 may be integrally made of a conductive material such as metal.

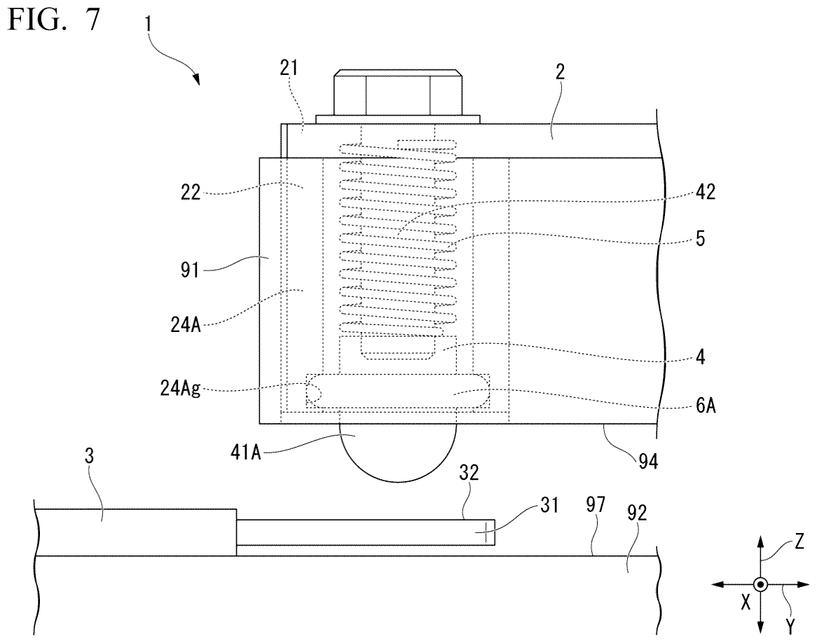

In the present embodiment, the relay conductive portion 6 is fixed to the movable conductive portion 4 and is slidable with respect to the device conductive portion 2. Note that the relay conductive portion 6 may be configured in any manner as long as it can relay conduction between the device conductive portion 2 and the movable conductive portion 4. As a modification, as illustrated in FIG. 7, the relay conductive portion may be fixed to the device conductive portion and may be slidable with respect to the movable conductive portion. In FIG. 7, the connection structure 1 includes a relay conductive portion 6A, a peripheral wall 24A, and a pressing portion 41A instead of the relay conductive portion 6, the peripheral wall 24, and the pressing portion 41. The relay conductive portion 6A is fitted in a circumferential groove 24Ag formed in the peripheral wall 24A. The pressing portion 41A has a similar shape to the pressing portion 41 except that the pressing portion 41A does not have the circumferential groove 41g. With such a configuration of the relay conductive portion 6A, the peripheral wall 24A, and the pressing portion 41A, the relay conductive portion 6A is fixed to the device conductive portion 2 and is slidable with respect to the movable conductive portion 4.

In the present embodiment, the device conductive portion 2 includes the device busbar 21. Note that the device conductive portion 2 may be configured in any manner as long as the device conductive portion 2 is electrically connected to the device 91. As a modification, the device conductive portion 2 may include a high-voltage electric wire instead of the device busbar 21. When such a high-voltage electric wire is disposed, one end of the high-voltage electric wire may be electrically connected to the device 91, and the other end of the high-voltage electric wire may be electrically connected to the conductive housing 22 by welding or the like.

In the present embodiment, an upper surface of the peripheral wall 24 of the conductive housing 22 is in contact with a lower surface of the device busbar 21 so as to be electrically connected thereto. Note that any configuration may be adopted as long as the conductive housing 22 can relay conduction between the device conductive portion 2 and the relay conductive portion 6. As a modification, the conductive housing 22 including the peripheral wall 24 and the device busbar 21 may be integrally made of a conductive material such as metal.

### Second Embodiment

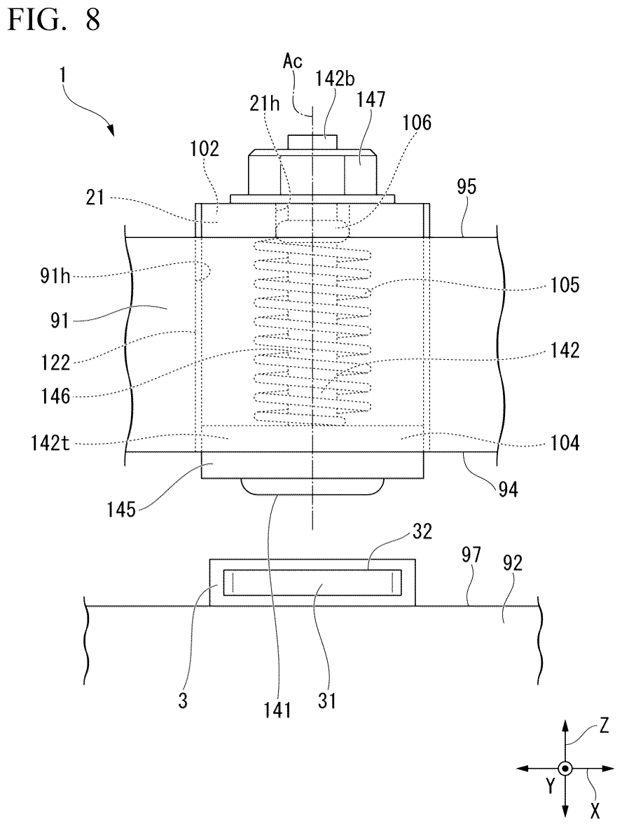

Hereinafter, an assembly according to an embodiment will be described with reference to FIGS. 8 to 12. The assembly of the present embodiment has a similar configuration, is assembled in a similar manner, and exhibits similar operation and effect to the assembly of the first embodiment except for the following points.

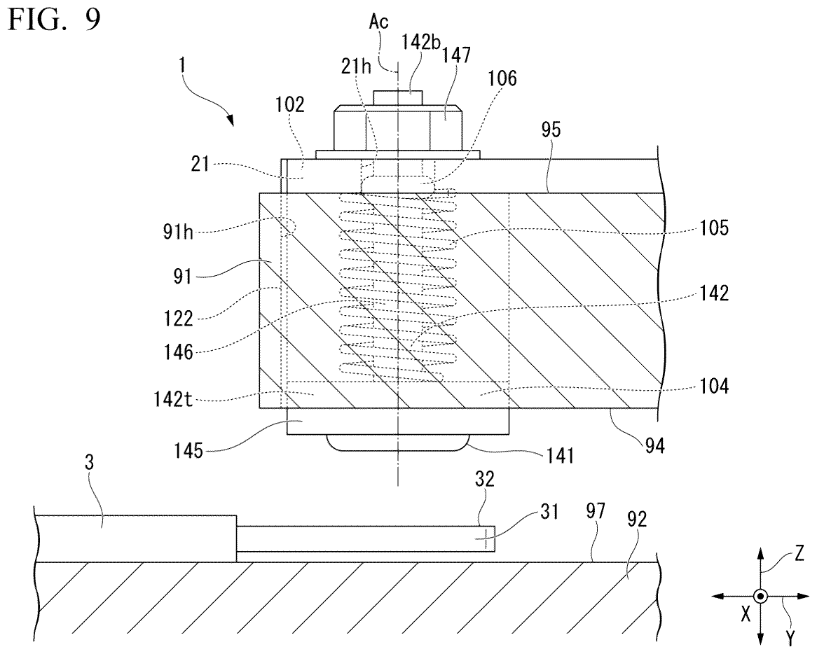

As illustrated in FIGS. 8 and 9, in the present embodiment, each connection structure 1 includes a device conductive portion 102 (second conductive portion), a battery conductive portion 3 (first conductive portion), a movable conductive portion 104, a biasing portion 105, and a relay conductive portion 106.

### (Configuration of Device Conductive Portion)

The device conductive portion 102 is electrically connected to a device 91. The device conductive portion 102 includes a device busbar 21 (second busbar). The device conductive portion 102 is disposed at a position away from the battery conductive portion 3. For example, the device conductive portion 102 may further include a cylindrical housing 122. The housing 122 is fitted in a through hole 91h. The housing 122 may be made of a conductive material such as metal, or may be made of an insulating material.

### (Configuration of Movable Conductive Portion)

The movable conductive portion 104 is movable in the Z direction with respect to the device conductive portion 102 and the battery conductive portion 3. The movable conductive portion 104 includes a pressing portion 141 capable of coming into contact with a battery busbar 31 and a shaft body 142.

### (Pressing Portion)

The pressing portion 141 can come into contact with the contact surface 32 of the battery busbar 31. The pressing portion 141 has an annular shape. The pressing portion 141 is made of a conductive material such as metal. For example, the pressing portion 141 may be an annular obliquely wound coil spring.

### (Shaft Body)

The shaft body 142 penetrates the through hole 91h of the device 91. For example, the shaft body 142 may be disposed in a cavity in the housing 122. The shaft body 142 has a base end 142b and a tip end 142t. The shaft body 142 extends from the base end 142b toward the tip end 142t around a central axis Ac extending in the Z direction. The shaft body 142 includes a disk portion 145, a conduction shaft 146, and a nut 147.

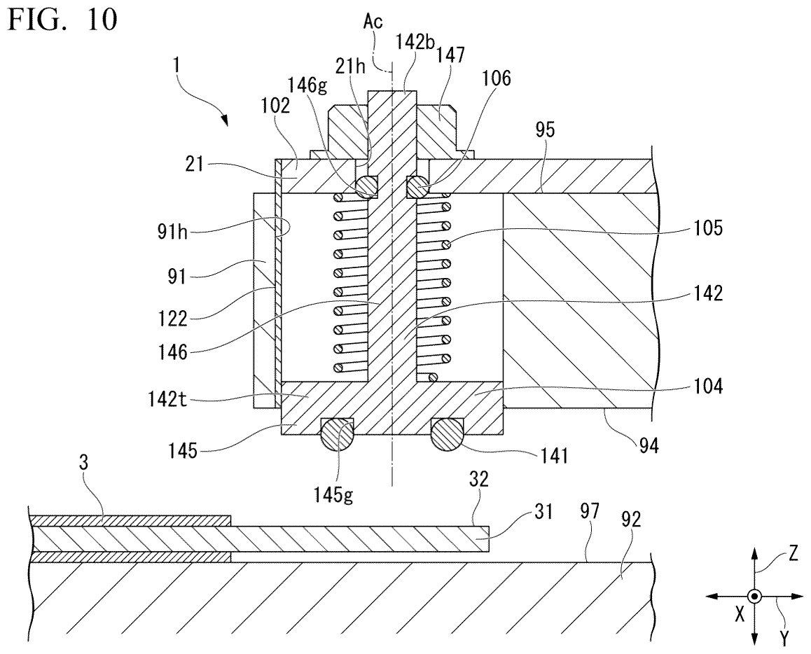

The shaft body 142 includes the disk portion 145 at the tip end 142t. The disk portion 145 has a disk shape centered on the central axis Ac. As illustrated in FIG. 10, the disk portion 145 has an annular groove 145g on a lower surface thereof. The annular groove 145g has an annular shape centered on the central axis Ac and is recessed upward. The pressing portion 141 is fixed to the disk portion 145 by being fitted in the annular groove 145g. The disk portion 145 is made of a conductive material such as metal.

The conduction shaft 146 extends from the disk portion 145 to the base end 142b in the Z direction around the central axis Ac. The conduction shaft 146 is fixed to the disk portion 145. The conduction shaft 146 is electrically connected to the disk portion 145. For example, the conduction shaft 146 has a cylindrical shape centered on the central axis Ac. For example, the conduction shaft 146 has an annular circumferential groove 146g on an outer periphery thereof at a position in a shaft hole 21h of the device busbar 21. The circumferential groove 146g is recessed toward the central axis Ac. The conduction shaft 146 is made of a conductive material such as metal. For example, the disk portion 145 and the conduction shaft 146 may be an integrally formed object made of a conductive material such as metal.

The shaft body 142 further includes a nut 147 at the base end 142b. The nut 147 is attached to the conduction shaft 146. The nut 147 has an outer diameter larger than an inner diameter of the shaft hole 21h. Specifically, the nut 147 has a female screw on an inner periphery thereof. The nut 147 is screwed into and fixed to a male screw of the conduction shaft 146 penetrating the shaft hole 21h and protruding above the device busbar 21 from an upper side of the device busbar 21. According to the fixing of the nut 147, the shaft body 142 has a structure in which an outer periphery thereof is enlarged at the base end 142b such that the shaft body 142 penetrating the shaft hole 21h does not come out toward the battery conductive portion 3. On the other hand, regardless of the fixing of the nut 147, the movable conductive portion 104 is movable in an upward direction which is a direction away from the battery conductive portion 3 with respect to the device busbar 21. The nut 147 may be made of a conductive material such as metal, or may be made of an insulating material.

### (Configuration of Biasing Portion)

The biasing portion 105 can bias the movable conductive portion 104 toward the contact surface 32. The biasing portion 105 is elastically deformable in the Z direction. The biasing portion 105 extends in the Z direction coaxially with a central axis of the shaft body 142. The biasing portion 105 has an end fixed to the device busbar 21 and the other end fixed to the disk portion 145. For example, the biasing portion 105 may be a coil spring having the central axis line Ac as a central axis.

### (Configuration of Relay Conductive Portion)

The relay conductive portion 106 relays conduction between the device conductive portion 102 and the movable conductive portion 104. The relay conductive portion 106 is in contact with an outer peripheral surface of the conduction shaft 146 and an inner peripheral surface of the shaft hole 21h of the device busbar 21. For example, the relay conductive portion 106 is in contact with the circumferential groove 146g of the conduction shaft 146 and an inner peripheral surface of the shaft hole 21h of the device busbar 21. By being fitted in the circumferential groove 146g, the relay conductive portion 106 is fixed to the movable conductive portion 104 in the Z direction, and is slidable with respect to the device conductive portion 102. Specifically, the relay conductive portion 106 is fixed to an outer peripheral surface of the conduction shaft 146 in the Z direction, and is slidable with respect to an inner peripheral surface of the device busbar 21. The relay conductive portion 106 is elastically deformable in a radial direction of the shaft body 142 so as to come into contact with the conduction shaft 146 and the device conductive portion 102. The relay conductive portion 106 is made of a conductive material such as metal. For example, the relay conductive portion 106 may be an annular obliquely wound coil spring fitted in the circumferential groove 146g.

### (Configuration of Fastening Material)

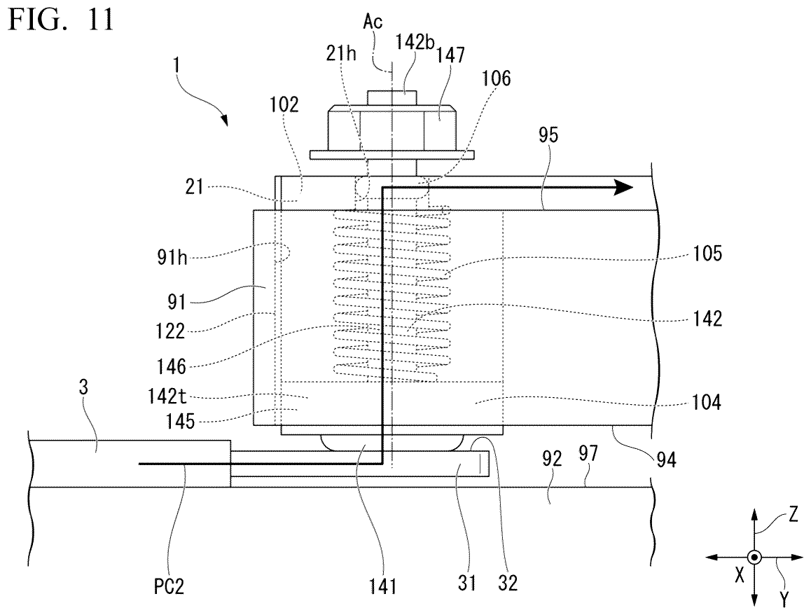

A plurality of fastening materials 93 fastens the device 91 and a battery pack 92 to each other. In assembling an assembly 9, for example, when the device 91 is fastened to the battery pack 92 by the fastening materials 93 so as to bring the device 91 close to the battery pack 92, the pressing portion 141 comes into contact with the contact surface 32 as illustrated in FIG. 11. When the device 91 is further fastened, the pressing portion 141 receives a pressing force upward from the contact surface 32.

Since the movable conductive portion 104 is movable in the Z direction with respect to the device conductive portion 102 and the battery conductive portion 3, the pressing portion 141 that has received the pressing force elastically deforms the biasing portion 105. On the other hand, the elastically deformed biasing portion 105 can apply a biasing force toward the contact surface 32 to the pressing portion 141. Due to this deformation and biasing force, in the assembled assembly 9, the pressing portion 141 can come into contact with the contact surface 32 while absorbing the pressing force from the contact surface 32 by the biasing portion 105. As a result of the contact, for example, the connection structure 1 can be electrically connected to the device conductive portion 102 and the battery conductive portion 3 such that a current flows through a current path PC2 illustrated in FIG. 11.

### (Operation and Effect of the Invention)

According to the connection structure 1 of the present embodiment, the relay conductive portion 106 is slidable with respect to the device conductive portion 102. On the other hand, the biasing portion 105 can bias the movable conductive portion 104 toward the contact surface 32. With such a relay conductive portion 106 and biasing portion 105, the movable conductive portion 104 can come into contact with the contact surface 32 while being biased toward the contact surface 32 and absorbing the pressing force from the contact surface 32 by the biasing portion 105. With such a contact, the connection structure 1 can absorb a manufacturing tolerance related to electrical connection between the device conductive portion 102 and the battery conductive portion 3, which is likely to occur at the time of assembling the device 91 and the battery pack 92. Therefore, the connection structure 1 of the present embodiment can easily ensure a contact pressure between the device conductive portion 102 and the battery conductive portion 3.

In addition, according to an example of the connection structure 1 of the present embodiment, the relay conductive portion 106 is elastically deformable so as to come into contact with the conduction shaft 146 and the device conductive portion 102. Due to such an elastic deformation, an electrical connection between the conduction shaft 146 and the device conductive portion 102 is easily stabilized. Therefore, the connection structure 1 of the present embodiment can stabilize an electrical connection between the device conductive portion 102 and the battery conductive portion 3.

In addition, according to an example of the connection structure 1 of the present embodiment, the relay conductive portion 106 is slidable so as to come into contact with the shaft body 142 and the device busbar 21. With such a contact, the electrical connection between the device conductive portion 102 and the battery conductive portion 3 can stabilized regardless of the structure of the device busbar 21.

In addition, according to an example of the connection structure 1 of the present embodiment, since the movable conductive portion 104 includes the shaft body 142, the connection structure 1 is not limited to the structure and positional relationship with the device busbar 21 and the battery busbar 31, and can have a structure in which the pressing portion 141 is easily brought into contact with the contact surface 32.

In addition, according to an example of the connection structure 1 of the present embodiment, the pressing portion 141 is an annular obliquely wound coil spring. In the case of the obliquely wound coil spring, a coil portion of the obliquely wound coil spring is warped by contact with the battery busbar 31, whereby the obliquely wound coil spring and the battery busbar 31 are connected to each other. With such a connection, even when the device busbar 21 or the battery busbar 31 is inclined in a longitudinal direction due to a manufacturing tolerance or an assembly tolerance of the device busbar 21 or the battery busbar 31, stable connection is possible due to warp of the lower obliquely wound coil spring.

In addition, according to an example of the connection structure 1 of the present embodiment, since the relay conductive portion 106 is an obliquely wound coil spring, the obliquely wound coil spring is deformably held between the device conductive portion 102 and the movable conductive portion 104. With such holding, the movable conductive portion 104 is allowed to be inclined with respect to the central axis Ac, and even when the device busbar 21 or the battery busbar 31 is inclined, the lower obliquely wound coil spring can be brought into contact with the battery busbar 31 perpendicularly.

### (Modification)

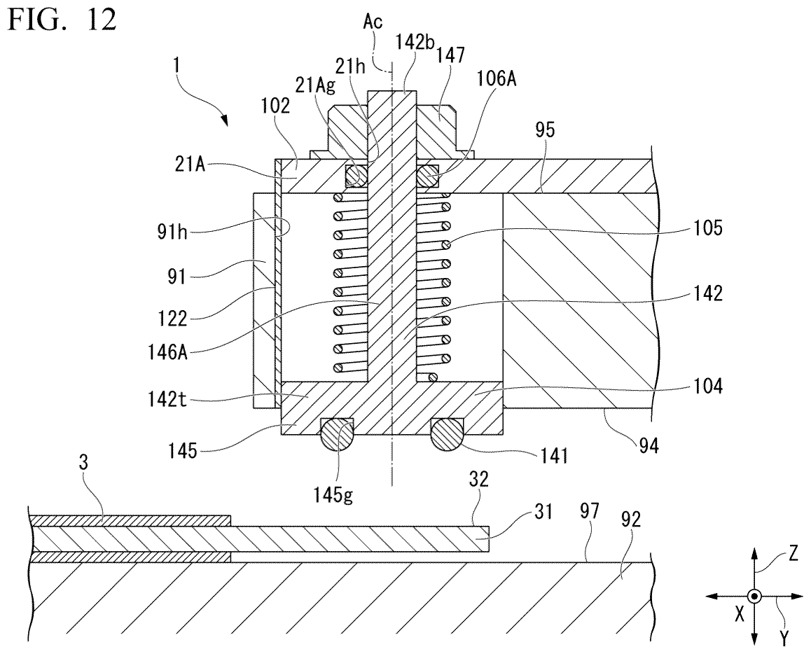

In the present embodiment, the relay conductive portion 106 is fixed to the movable conductive portion 104 and is slidable with respect to the device conductive portion 102. Note that the relay conductive portion 106 may be configured in any manner as long as it can relay conduction between the device conductive portion 102 and the movable conductive portion 104. As a modification, as illustrated in FIG. 12, the relay conductive portion may be fixed to the device conductive portion and may be slidable with respect to the movable conductive portion. In FIG. 12, the connection structure 1 includes a relay conductive portion 106A, a device busbar 21A (second busbar), and a conduction shaft 146A instead of the relay conductive portion 106, the device busbar 21, and the conduction shaft 146. The relay conductive portion 106A is fitted in a circumferential groove 21Ag formed in the device busbar 21A. The conduction shaft 146A has a similar shape to the conduction shaft 146 except that the conduction shaft 146A does not have the circumferential groove 146g. With such a configuration of the relay conductive portion 106A, the device busbar 21A, and the conduction shaft 146A, the relay conductive portion 106A is fixed to the device conductive portion 102 and is slidable with respect to the movable conductive portion 104.

According to an example of the present embodiment, the pressing portion 141 is an annular obliquely wound coil spring. Note that the pressing portion 141 may be configured in any manner as long as it can come into contact with the contact surface 32 of the battery busbar 31. As a modification, the pressing portion 141 may be a conductive plate made of metal or the like or a conductive block made of metal or the like having a plane or a curved surface on the contact surface 32 side, instead of the annular obliquely wound coil spring.

### <Other Modifications>

In each of the above-described embodiments, the second conductive portion is connected to the device 91, and the first conductive portion is connected to the battery pack 92. Note that, as a modification, in the connection structure 1, the device conductive portion 2, 102 and the battery conductive portion 3 may be configured to be reversed. That is, in a modification, the connection structure 1 may be configured such that the first conductive portion is connected to the device 91 and the second conductive portion is connected to the battery pack 92.

In an example of each of the above-described embodiments, the biasing portion is a coil spring. Note that the biasing portion may be configured in any manner as long as the movable conductive portion can be biased toward the contact surface 32. As a modification, the biasing portion may be a cylindrical elastic body (rubber bush or the like), a conductive housing, or an oil damper structure in which a housing is filled with oil. In the case of the oil damper structure, the biasing portion may further include a sealing structure.

In an example of each of the above-described embodiments, the relay conductive portion is an annular obliquely wound coil spring. Note that the relay conductive portion may be configured in any manner as long as it can relay conduction between the device conductive portion and the movable conductive portion. The relay conductive portion may be a spring contact or the like in which a plate-shaped member is fixed to one of the movable conductive portion and the device conductive portion and a contact is directed to the other of the movable conductive portion and the device conductive portion. Note that since a contact area of the spring contact or the like is small, when it is necessary to ensure a contact area for allowing a high current to flow, the relay conductive portion is preferably an annular obliquely wound coil spring.

While the embodiments of the present disclosure have been described above, it should be understood that these embodiments are exemplary examples of the present disclosure and are not to be considered as limiting. These embodiments can be implemented in various other forms, and various omissions, substitutions, and other modifications can be made without departing from the scope of the present disclosure. Accordingly, the invention is not to be considered as being limited by the foregoing description, and is only limited by the scope of the appended claims.

### INDUSTRIAL APPLICABILITY

According to the connection structure and the assembly of the present disclosure, it is easy to ensure a contact pressure between conductive portions.

### DESCRIPTION OF THE REFERENCE SYMBOLS

1 Connection structure
2 Device conductive portion (second conductive portion)
3 Battery conductive portion (first conductive portion)
4 Movable conductive portion
5 Biasing portion
6 Relay conductive portion
6A Relay conductive portion
9 Assembly
21 Device busbar (second busbar)
21A Device busbar (second busbar)
21Ag Circumferential groove
21h Shaft hole
22 Conductive housing
23 Bottom plate
23t Bottom surface
23w Opening
24 Peripheral wall
24A Peripheral wall
24Ag Circumferential groove
24s Inner peripheral surface
31 Battery busbar (first busbar)
32 Contact surface
33 Boss
34 Recessed portion
41 Pressing portion
41A Pressing portion
41g Circumferential groove
42 Shaft body
42b Base end
42t Tip end
43 Boss
91 Device
91h Through hole
92 Battery pack
92h Hole
93 Fastening material
94 Facing surface
95 First installation surface
96 Flange portion
96h Through hole
97 Second installation surface
102 Device conductive portion (second conductive portion)
104 Movable conductive portion
105 Biasing portion
106 Relay conductive portion
106A Relay conductive portion
122 Housing
141 Pressing portion
142 Shaft body
142b Base end
142t Tip end
145 Disk portion
145g Annular groove
146 Conduction shaft
146A Conduction shaft
146g Circumferential groove
147 Nut
Ac Central axis
PC1 Current path
PC2 Current path

What is claimed is:

1. A connection structure comprising:
a first conductive portion including a first busbar having a contact surface;
a second conductive portion disposed at a position away from the first conductive portion;
a movable conductive portion including a pressing portion capable of coming into contact with the first busbar and the movable conductive portion being movable with respect to the first conductive portion and the second conductive portion in a moving direction intersecting with the contact surface;
a biasing portion capable of biasing the movable conductive portion toward the contact surface; and
a relay conductive portion relaying conduction between the second conductive portion and the movable conductive portion,
wherein the relay conductive portion is slidable with respect to the second conductive portion or the movable conductive portion.

2. The connection structure according to claim 1, wherein
the relay conductive portion is elastically deformable so as to come into contact with the pressing portion and the second conductive portion.

3. The connection structure according to claim 1, wherein
the second conductive portion includes a second busbar and a conductive housing that supports one end of the second busbar, and
the relay conductive portion is slidable so as to come into contact with the pressing portion and the conductive housing.

4. The connection structure according to claim 1, wherein
the movable conductive portion further includes a conduction shaft extending in the moving direction, and
the relay conductive portion is elastically deformable so as to come into contact with the conduction shaft and the second conductive portion.

5. The connection structure according to claim 4, wherein
the second conductive portion includes a second busbar, and
the relay conductive portion is slidable so as to come into contact with the conduction shaft and the second busbar.

6. The connection structure according to claim 1, wherein
the second conductive portion includes a second busbar, and
the movable conductive portion includes a shaft body having a tip end fixed to the pressing portion, the shaft body penetrating the second busbar from the tip end and extending in the moving direction.

7. An assembly comprising:
the connection structure according to claim 1;
a battery pack connected to the first conductive portion; and
a device connected to the second conductive portion.
